(19) United States
(12) Patent Application Publication
(10) Pub. No.: US 2019/0242293 A1
(43) Pub. Date: Aug. 8, 2019

(54) AN ALTERNATE PROCEDURE FOR OPERATING AN IC ENGINE

(71) Applicants: Abhijit MAJAGE, Thergaon Pune (IN); Jaypal Uttam MOHITE, Pune (IN); Brijraj Uttam MOHITE, Sangli (IN); Mrinalini Jaypal MOHITE, Pune (IN)

(72) Inventors: Jaypal Uttam Mohite, Pune (IN); Brijraj Uttam Mohite, Kadegaon, Sangli (IN); Mrinalini Jaypal Mohite, Pune (IN)

(21) Appl. No.: 16/322,928

(22) PCT Filed: Oct. 16, 2017
(86) PCT No.: PCT/IB2017/056398

§ 371 Date: Feb. 2, 2019

(30) Foreign Application Priority Data
Oct. 27, 2016 (IN) 201621036969

(51) Int. Cl. F02B 3/00

(52) U.S. Cl. CPC F02B 3/00; F02G 3/02

(57) ABSTRACT

The present disclosure envisages an engine operating on Jaypal cycle. The engine comprises a compressed air source. A combustion chamber is in fluid communication with the compressed air source and a fuel source, wherein the combustion chamber is configured to allow combustion of a fuel charge to produce combusted fuel charge. A first storage tank is in fluid communication with the combustion chamber, wherein the first storage tank is configured to store the combusted fuel charge, which is high pressure high temperature gas to perform work as per application requirements.

### FIELD

The present disclosure relates to the field of internal combustion engines.

### Definition

The term “Jaypal Cycle” has been coined by the inventors of the present invention and has been used to describe the operational cycle of the engine as described in the present disclosure. For the purposes of this disclosure a Jaypal cycle is hereby defined as a thermodynamic cycle with heat addition at a constant volume and work done at a constant pressure.

The term “First Storage Tank” refers to one or more storage tanks or devices used for storing the high temperature high pressure combusted fuel charge.

### BACKGROUND

Conventional internal combustion (IC) engines generally include a number of components such as a piston, a connecting rod, a crank, a crank shaft, and the like. For the operation of the engine, these components work in unison to provide a mechanical drive as an output. These conventional engines generally operate on basic Otto cycle, Diesel cycle, Wankel cycle, or any other relevant cycle. All the existing IC engine cycles perform a series of operations which are continuous in time. Also, the known cycles do not envisage a process of addition of heat at a constant volume and work done at constant pressure.

There is need for an engine working on a cycle wherein addition of heat is performed at a constant volume and work is done at a constant pressure. Furthermore, there is need of an engine which operates on a cycle that is independent of time.

### OBJECTS

Some of the objects of the present disclosure, which at least one embodiment herein satisfies, are as follows.

It is an object of the present disclosure to ameliorate one or more problems of the state of the art or to at least provide a useful alternative.

An object of the present disclosure is to provide an engine operating on Jaypal cycle, which operates on a cycle with heat addition at a constant volume and work done at a constant pressure.

An object of the present disclosure is to provide an engine operating on Jaypal cycle, which has lesser number of components as compared to the conventional internal combustion engines.

Another object of the present disclosure is to provide an engine operating on Jaypal cycle, which is more efficient as compared to the conventional internal combustion engines.

Other objects and advantages of the present disclosure will be more apparent from the following description, which is not intended to limit the scope of the present disclosure.

### SUMMARY

The present disclosure envisages an engine operating on Jaypal cycle. The engine comprises a compressed air source. A combustion chamber is in fluid communication with the compressed air source and a fuel source, wherein the combustion chamber is configured to allow combustion of a fuel charge to produce combusted fuel charge. The combustion chamber comprises a housing defined by a body of the combustion chamber. At least one inlet valve is disposed adjacent each operative end of the combustion chamber. At least one fuel injector is disposed adjacent each operative end of the combustion chamber. At least one outlet valve disposed adjacent each operative end of the combustion chamber. A piston is disposed within the combustion chamber, wherein the piston is displaceable within the combustion chamber to facilitate an exhaust of the combusted fuel charge from each of the at least one outlet valve. A first storage tank is in fluid communication with the combustion chamber, wherein the first storage tank is configured to store the combusted fuel charge, which is high pressure high temperature gas to perform work as per application requirements. A Jaypal cycle engine typically would operate with pressurized air intake but without a compression stroke as it occurs in the conventional internal combustion engine, would have an expansion step with concomitant expansion and decrease in charge pressure but without a power stroke. The engine would operate without direct mechanical drive but via an air motor which would perform work utilizing the high PT charge produced by the combustion chamber.

In an embodiment, the combustion chamber further comprises at least one ignition element disposed adjacent each operative end of the combustion chamber, wherein the ignition element is one of a sparkplug or an ignition coil.

In another embodiment, the combustion chamber further comprises at least one proximity sensor disposed at each operative end of the combustion chamber, wherein the at least one sensor is configured to provide at least one feedback of position of the piston, pressure within the combustion chamber, and the temperature within the combustion chamber to an Electronic Control Unit (ECU).

In another embodiment, the compressed air source comprises an air compressor. In yet another embodiment, the compressed air source further comprises a second storage tank in fluid communication with the air compressor, wherein the second storage tank is configured to store compressed air and supply the compressed air to the combustion chamber.

In another embodiment, the combustion chamber is configured to facilitate the combustion of the fuel charge at least one operative end of the combustion chamber when the piston is spaced apart from said operative end.

The present disclosure also envisages a process for operating an engine based on Jaypal cycle. The process comprises the following steps:
compressing the atmospheric air;
supplying the compressed air to a combustion chamber for facilitating combustion of a fuel charge in the combustion chamber and thus providing constant volume heat addition to the fuel charge to obtain combusted fuel charge;
supplying the combusted fuel charge to a storage tank, where expansion of the combusted fuel charge occurs, which is characterized by increased volume and reduced pressure relative to the pressure of combusted fuel charge in the combustion chamber and substantially equal to the pressure of the compressed air, thereby obtaining the high pressure high temperature gas; and
supplying the high pressure high temperature gas to a load.

### BRIEF DESCRIPTION OF THE ACCOMPANYING DRAWING

An engine operating on Jaypal cycle, will now be described with the help of non-limiting accompanying drawing, in which:

FIG. 1 illustrates a graphical representation of the change in pressure with respect to the change in volume of the Jaypal cycle (engine operational cycle), in accordance with the present disclosure;

FIG. 2 illustrates a block diagram depicting the work stages of the Jaypal cycle of FIG. 1;

FIG. 3 illustrates a schematic diagram of a system for producing high pressure high temperature gas, operating in accordance with the Jaypal cycle;

FIG. 4 illustrates a schematic view of a combustion chamber operating on the Jaypal cycle, in accordance with an embodiment of the present disclosure; and

FIG. 5 illustrates a schematic view of a storage tank coupled to the engine of FIG. 4.

### DETAILED DESCRIPTION

Internal combustion engines generally operate according to the engine operational cycles. For example, a compression ignition engine operates according to the Diesel cycle, and a spark ignition engine operates according to the Otto cycle. The inventors of the present disclosure have envisaged a novel operational cycle for an engine, which has been termed as “Jaypal cycle”.

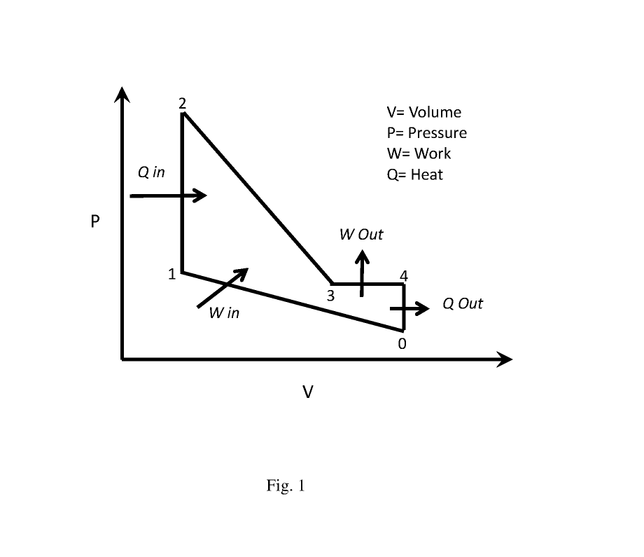

FIG. 1 illustrates a graphical representation of the change in pressure with respect to the change in volume of the Jaypal cycle. In FIG. 1A, process 0-1 depicts the atmospheric air compression inside the engine operating according to the Jaypal cycle. Process 1-2 depicts heat addition at a constant volume of a charge (mixture of air and fuel) inside an engine operating according to the Jaypal cycle. Process 2-3 depicts expansion of the charge wherein the pressure of the charge is reduced and volume is increased. Process 3-4 depicts the work done by releasing the constant pressure and volume through the air motor which is coupled to the engine storage tank of the engine operating according to the Jaypal cycle. Process 4-0 is heat rejection process operating according to the Jaypal cycle. Again, the process 0-1 repeats, which depicts the atmospheric air compression inside the engine operating according to the Jaypal cycle.

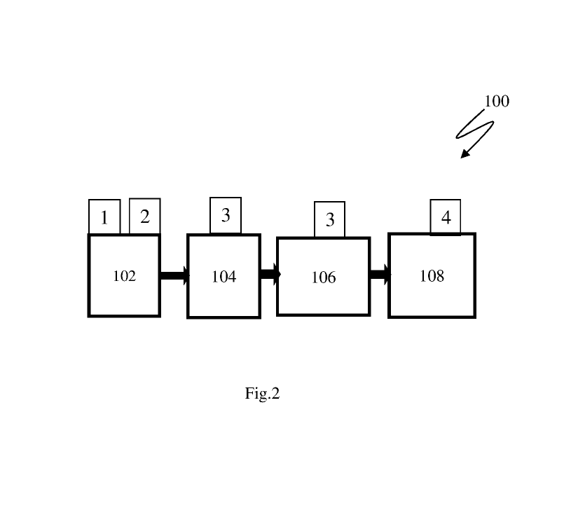

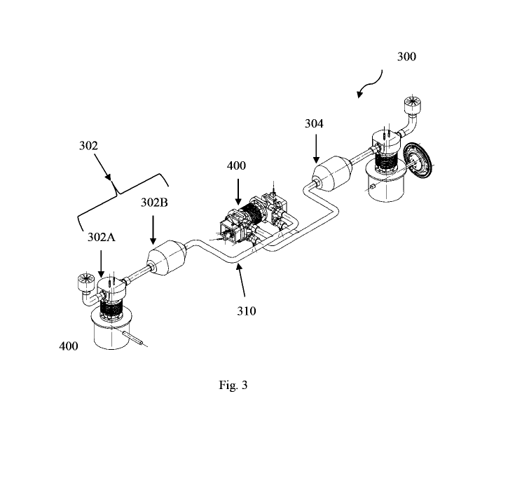

FIG. 2 illustrates a block diagram depicting the work stages 100 of the Jaypal cycle. Block 102 depicts the process 1-2 inside the combustion chamber of the engine. During process 1-2, the combustion of the charge occurs inside the engine which causes an increase in the pressure and temperature of the charge inside the engine. Block 104 depicts the beginning of the process 2-3 of the Jaypal cycle. More specifically, at block 104 the charge, with the high pressure and temperature, is transferred to a storage tank (as shown in FIG. 3) wherein the expansion of the charge takes place which causes a reduction in the pressure and an increase in the volume of the charge. In an embodiment, the storage tank is an insulated storage tank. At block 106, instructions are received from an ECU to control the pressure and air flow. During process 3-4, at block 108, the charge is transferred from the storage tank to load equipment, e.g., an air motor.

A feature of the Jaypal cycle is that it operates using the different mechanical components such as a compressed air source, a combustion chamber, a storage tank, and an air motor working as load equipment. As discussed above, the Jaypal cycle involves the steps of compressing air; supplying the compressed air to the combustion chamber for facilitating combustion of a fuel charge; and finally storing the high pressure high temperature combusted fuel charge for performing work.

FIG. 3 illustrates a schematic diagram of an engine for producing high pressure high temperature gas 300 (hereinafter referred to as engine 300), operating in accordance with the Jaypal cycle. As seen in FIG. 3, the engine 300 comprises a compressed air source 302. In accordance with an embodiment of the present disclosure, the compressed air source is a compressor 302A. In accordance with another embodiment, the compressed air source 302 further comprises a second storage tank 302B that is configured to store the compressed air produced by the compressor 302A. The purpose of storing the compressed air in the second storage tank 302B is to facilitate a non-intermittent and a continuous supply of the compressed air to a combustion chamber 400. Compressed air is directed to the combustion chamber through a compressed air conduit 310. The combustion chamber 400 that is in fluid communication with the compressed air source 302 and a fuel source (not shown in figures), wherein the combustion chamber 400 is configured to allow combustion of a fuel charge to produce the high pressure high temperature gas. The combustion chamber 400 has been described in the subsequent sections of the present disclosure. A first storage tank 304 is in fluid communication with the combustion chamber 400, wherein the first storage tank 304 is configured to store the combusted fuel charge, which is a high pressure high temperature gas to perform work as per application requirements. In an embodiment, the first storage tank 304 is an insulated storage tank. In one embodiment, the combustion chamber 400 is also insulated, and the ducts that facilitate the fluid communication between the combustion chamber 400 and the first storage tank 304 are insulated as well.

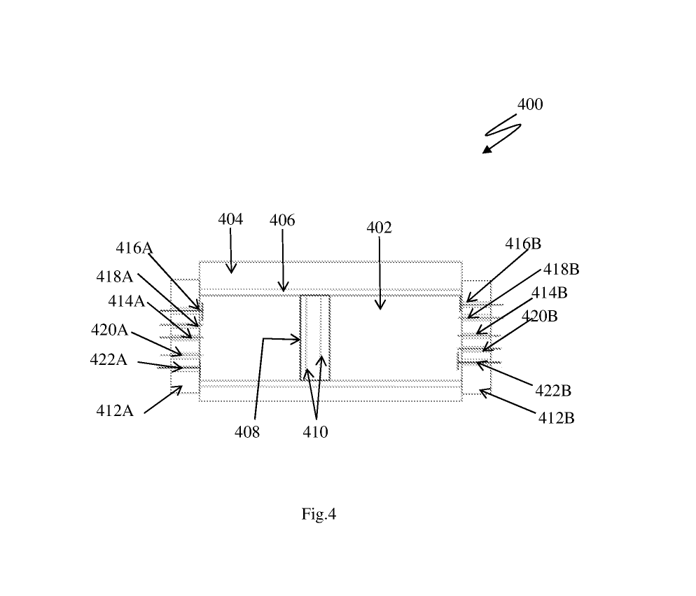

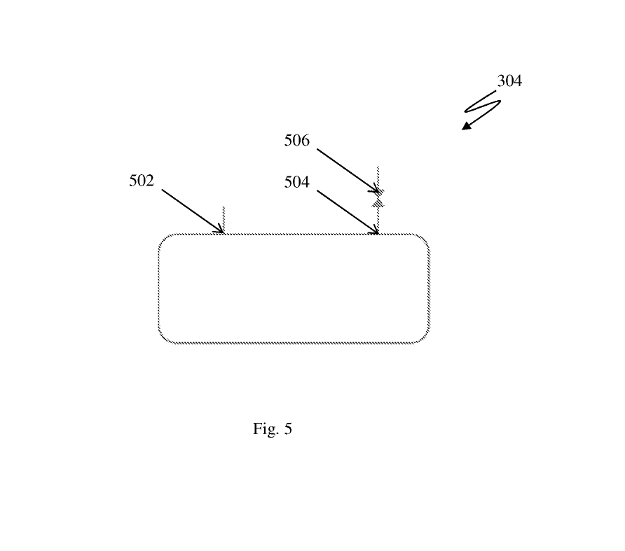

FIG. 4 illustrates a schematic view of a combustion chamber 400 operating on the Jaypal cycle. FIG. 5 illustrates a schematic view of the storage tank coupled to the combustion chamber 400, as seen in FIG. 3. The combustion chamber 400 comprises a housing 402 defined by a body 404. The body 404 is provided with a liner 406 on an inner periphery thereof. The combustion chamber 400 further includes a piston 408 provided with piston rings 410. In an embodiment, the piston rings 410 are separate components fitted onto the piston 408. In another embodiment, the piston 408 has a protrusion which extends along the periphery of the piston to function as a piston ring. The piston 408 divides the housing 402 into two sub chambers. The piston rings 410 prevent the leakage of the charge or any gaseous matter from one sub chamber of the housing 402 into the other sub chamber. The body 404 is provided with cylinder heads 412A, 412B on either side of the body 404. Each cylinder head 412A, 412B is provided with at least one ignition element 414A, 414B, at least one inlet valve 416A, 416B, at least one sensor 418A, 418B, at least one fuel injector 420A, 420B, and at least one outlet valve 422A, 422B. Inlet valves 416A, 416B regulate flow of compressed air conducted through conduit 310 into the combustion chamber. The outlet valves 422A, 422B are in fluid communication with the first storage tank 304 that stores the high pressure high temperature gas, i.e., the combusted fuel charge. It is to be noted that the positions of the ignition element 414A, 414B, the inlet valve 416A, 416B, the sensor 418A, 418B, the outlet valve 422A, 422B, and the fuel injector 420A, 420B is not limited to being on the cylinder heads 412A, 412B and can also be configured on the combustion chamber 400 adjacent the operative ends of the combustion chamber 400. In an embodiment, the ignition element 414A, 414B is a sparkplug or an ignition coil. The first storage tank 304 is defined by a container that has an inlet port 502 and an outlet port 504. The outlet port 504 is in fluid communication with a pressure regulator 506 that regulates the discharge of the charge from the first storage tank 304. In an embodiment, the sensors 418A, 418B can be a pressure sensor or a displacement sensor or a temperature sensor, or any combination thereof.

One feature of the combustion chamber 400 is that the combustion chamber 400 is so configured to facilitate combustion of the fuel charge at an operative end of the housing 402, when the piston 408 is proximal the opposite operative end of the housing 402. A drawback of the conventional internal combustion engine is that the combustion of the fuel charge takes place when the piston is at the Top Dead Centre (TDC). Due to such an operation, there is very less space, and consequently less air, available for efficiently combusting the fuel charge, which leads to incomplete combustion of the fuel charge. The combustion chamber 400 addresses the aforementioned drawback by allowing the combustion of the fuel charge at the operative end housing 402, when the piston 408 is adjacent the opposite operative end of the housing 402, thereby providing maximum volume for combustion of the fuel charge in the combustion chamber. Due to such a configuration, the fuel charge has the entire volume of one of the sub-chambers, and consequently, higher volume of air available for combusting the fuel charge. This leads to a substantially complete combustion of the fuel charge, which improves the power output and efficiency of the engine 300, while at the same time reducing the emissions by the engine 300.

The present disclosure also envisages a process for producing high pressure high temperature gas to perform work. The process comprises the following steps:
compressing the atmospheric air, which is performed by the compressed air source 302;
supplying the compressed air to the combustion chamber 400 for facilitating combustion of a fuel charge in the combustion chamber 400 and thus providing constant volume heat addition to the fuel charge to obtain combusted fuel charge;
supplying the combusted fuel charge to the first storage tank 304, where expansion of the combusted fuel charge occurs, which causes increased volume and reduced pressure relative to the pressure and volume of combusted fuel charge in the housing 402 and substantially equal to the pressure of the compressed air, thereby obtaining the high pressure high temperature gas;
supplying the high pressure high temperature gas to a load, wherein the supply is characterized by constant pressure and increased volume;
using the high pressure high temperature to perform work on the load; and
it is to be noted that load can be any application in which high pressure high temperature gas can be used to perform work.

The operative configuration of the engine 300 with respect to the Jaypal cycle is hereinafter described. Initially, all the valves of the combustion chamber 400 are in a closed configuration. When the operation of the combustion chamber 400 starts, the inlet valve 416A is opened, and simultaneously, the outlet valve 422B is also opened, thereby allowing compressed air at pressure P1, volume V1, and temperature T1 from the compressed air source 302 to enter inside the housing 402. The pressurized air entering the combustion chamber 400 from the inlet valve 416A pushes the piston 408 towards the opposite operative end of the combustion chamber 400. When the housing 402 is completely filled with the compressed air, the sensor 418A provides a feedback to the ECU (electronic control unit), thereby closing the inlet valve 416A and outlet valve 422B. Once the inlet valve 416A is closed, the ECU sends a signal to the fuel injector 420A to inject the required amount of fuel (petrol/diesel/any other type) inside the housing 402. After completion of fuel injection or during fuel injection, the ECU will send a signal to the ignition element 414A to facilitate ignition inside the housing 402, which will initiate fuel combustion inside the housing 402, in accordance with the process 1-2 of the Jaypal cycle. It is to be noted that the fuel charge that is to be combusted in the combustion chamber 400 can be any fuel, e.g., Liquid Petroleum Gas, Compressed Natural Gas, petrol, diesel, a mixture of air and any of the known fuels, and the like. In this process, there will be rise in the temperature and pressure of the charge due to addition of heat. This process is called as constant volume heat addition process. During this process, the combusted fuel charge is at a pressure P2, Volume V2, and temperature T2 such that P1<P2, T1<T2, and V1=V2. It is to be noted that the combustion in the housing 402 takes place at one operative end when the piston is present adjacent the opposite operative end. After the combustion of the fuel, the ECU instructs the outlet valve 422A to open, while simultaneously instructing the inlet valve 416B to also open. The outlet valve 422A is in fluid communication with the first storage tank 304 to store the high pressure, high temperature charge therein. The combusted fuel charge, from the housing 402, enters the first storage tank 304 by the virtue of pressure difference between the housing 402 and the first storage tank 304 until the pressure equalizes between the section of the combustion chamber 400 and the first storage tank 304. At this point, combusted fuel charge expansion takes place where the pressure of the combusted fuel charge reduces and volume increases. Subsequent to that, the piston pushes the combusted fuel charge from the combustion chamber 400 into the first storage tank 304 under the influence of the fresh high pressure air supplied to the combustion chamber 400 from the inlet valve 416B placed at the operative opposite end thereof. More specifically, the piston 408 pushes the combusted fuel charge out of the combustion chamber 400 because of the force applied on the piston 408 by the fresh high pressure gas supplied to the combustion chamber 400 from the opposite operative end. The aforementioned operation repeats at the opposite operative end of the combustion chamber 400, and the piston 408 moves rapidly from left to right and right to left to fill the first storage tank 304 per further requirement. Such is the working of the engine 300 operating based on the Jaypal cycle.

Now, the pressure P3 of the charge inside the first storage tank 304 (per cycle diagram) is slightly less than P1 due to the expansion of combusted fuel charge. It is to be noted that P1 and P3 are very close to each other and can be considered substantially equal. So, the pressure P2 is reduced to P3, and the V2 increases to V3. As such, the storage tank has hot combusted fuel charge with volume V3, Pressure P3, and Temperature T3, wherein V3>V2, P3<P1, and T3<T2.

The present disclosure is further described in light of the following laboratory scale experiments which are set forth for illustration purpose only and not to be construed for limiting the scope of the disclosure. These laboratory experiments can be scaled up to industrial/commercial scale and the results obtained can be extrapolated to industrial/commercial scale.

Table 1 depicts the pressure and volume parameters at stage 1 of the engine operation, i.e., subsequent to the compression by the compressed air source.

TABLE 1

| Parameter | P1 (Pressure) | V1 (Volume) |
|---|---|---|
| Unit | Bar | Litre |
| Value (Range) | 10 | 2 |

As seen in Table 1, the pressure at the end of compression by the compressed air source is 10 bar and the volume is 2 litres.

Table 2 depicts the pressure and volume parameters at stage 2 of the engine operation, i.e., combustion of the fuel charge within the combustion chamber.

TABLE 2

| Parameter | P2 (Pressure) | V2 (Volume) |
|---|---|---|
| Unit | Bar | Litre |
| Value (Range) | >30 | 2 |

As seen in table 2, the pressure in the combustion chamber after the combustion of the fuel charge is more than or equal to 30 bars and the volume is 2 litres, i.e., the volume remains the same. Therefore, heat addition at constant volume occurs inside the combustion chamber.

Table 3 depicts the pressure and volume parameters at stage 3 of the engine operation, i.e., when the high pressure high temperature combusted fuel charge is supplied to the first storage tank.

TABLE 3

| Parameter | P3 (Pressure) | V3 (Volume) |
|---|---|---|
| Unit | Bar | Litre |
| Value (Range) | <10 | >6 |

As seen in table 3, the pressure in the combustion chamber after the combustion of the fuel charge is less than 10 bars and the volume is greater than 6 litres. The combusted fuel charge collected inside the first storage tank is a high pressure (pressure less than 10 bars) fluid which can be used to perform work. It is to be noted that minor heat losses resulting from friction and the like have been neglected in aforementioned experimentation.

The engine 300 of the present disclosure does not have a large number of components. The only components of the engine are the housing, the piston, and the cylinder head, and the engine does not include a connecting rod, a crank, and a crank shaft. As such, the frictional losses are reduced to a minimum. Furthermore, lesser number of components means lesser probability of failure. As such, the engine 300 of the present disclosure also has an improved service life.

It is also to be noted that the engine 300 of the present disclosure comprises elements which are so coupled with each other that they operate in a time-independent manner relative to each other. For example, the compressor 302A can remain in an inoperative state as long as the quantity of compressed air in the second storage tank 302B is filled, and the combustion chamber 400 can operate even when the compressor 302A is inoperative. Once the quantity of the compressed air in the second storage tank 302B drops a certain pre-determined value, the compressor 302A becomes operational. In accordance with one embodiment, the quantity of the compressed air in the second storage tank 302B is sensed by a sensor 302C which is coupled with the ECU (not shown in figures). Similarly, once the first storage tank is filled with the combusted fuel charge (high pressure high temperature gas), the operation of the combustion chamber is stopped, and even so the air motor or any other load coupled to the first storage tank can work independently.

### Technical Advances

The present disclosure described herein above has several technical advantages including, but not limited to, the realization of an engine operating on Jaypal cycle:
which has lesser number of components as compared to the conventional internal combustion engines;
which is more efficient as compared to the conventional internal combustion engines;
in which all four stages of the standard engine cycles are achieved in a time independent manner and without having any location constraints, i.e., the different components need not be at fixed locations and can be varied; and
in which heat addition and heat rejection occur at different locations.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. An engine operating on Jaypal cycle, said engine comprising:
a compressed air source;
at least one combustion chamber in fluid communication with said compressed air source and a fuel source, said combustion chamber defining two operative ends and configured to allow combustion of a fuel charge to produce high pressure high temperature gaseous combusted fuel charge, said combustion chamber comprises:
a housing defined by a body of said combustion chamber, said housing having a liner;
at least one inlet valve disposed adjacent each operative end of said combustion chamber;
at least one fuel injector disposed adjacent each operative end of said combustion chamber;
at least one outlet valve disposed adjacent each operative end of said combustion chamber; and
a piston having piston rings disposed within said combustion chamber, said piston being displaceable within said combustion chamber to facilitate an exhaust of said combusted fuel charge from each of said at least one outlet valve; and
a means for directing compressed air from said compressed air source to said combustion chamber; said at least one inlet valve configured to regulate flow of compressed air from said compressed air source into said combustion chamber;
a first storage tank in fluid communication with said combustion chamber, said first storage tank configured to store said combusted fuel charge, which is high pressure high temperature gas to perform work as per application requirements.

2. The engine as claimed in claim 1, wherein said combustion chamber further comprises at least one ignition element disposed adjacent each operative end of said combustion chamber.

3. The engine as claimed in claim 2, wherein said ignition element is at least one of a sparkplug and an ignition coil.

4. The engine as claimed in claim 1, wherein said combustion chamber further comprises at least one sensor disposed at each operative end of said combustion chamber, said at least one sensor configured provide feedback of position of said piston within said combustion chamber, pressure parameters within said combustion chamber, and temperature parameters within said combustion chamber to an Electronic Control Unit (ECU).

5. The engine as claimed in claim 1, wherein said compressed air source comprises an air compressor.

6. The engine as claimed in claim 5, wherein said compressed air source further comprises a second storage tank in fluid communication with said air compressor, said second storage tank configured to store compressed air and supply said compressed air to said combustion chamber.

7. The engine as claimed in claim 1, wherein said combustion chamber is configured to facilitate the combustion of said fuel charge at least one operative end of said combustion chamber when the piston is spaced apart from said operative end proximal an opposite operative end of said combustion chamber.

8. A process for operating an engine based on Jaypal cycle, said process comprising the following steps:
compressing the atmospheric air;
directing the compressed air through a means for directing the compressed air compressed air to a combustion chamber for facilitating combustion of a fuel charge in said combustion chamber and thus providing constant volume heat addition to said fuel charge to obtain combusted fuel charge;
supplying said combusted fuel charge to a storage tank, where expansion of said combusted fuel charge occurs, which causes increased volume and reduced pressure relative to the pressure and volume of said combusted fuel charge in said combustion chamber and substantially equal to the pressure of said compressed air, thereby obtaining said high pressure high temperature gas; and
supplying said high pressure high temperature gas to a load.

9. The process as claimed in claim 8, wherein:
P0<P1<P2;
P3<P1;
P3>=P4; and
P0<P4;
wherein P0 is a pressure of said atmospheric air;
wherein P1 is a pressure of said atmospheric air subsequent to said compression;
wherein P2 is a pressure of said combusted fuel charge subsequent to said constant volume heat addition;
wherein P3 is a pressure of said combusted fuel charge when stored within said storage tank and supplied to said load; and
wherein P4 pressure of said combusted fuel charge subsequent to work done at said load.

10. The process as claimed in claim 8, wherein:
V1<V0;
V1=V2;
V2<V3;
V3<V4; and
V4>=V0
wherein V0 is a volume of said atmospheric air;
wherein V1 is a volume of said atmospheric air subsequent to said compression;
wherein V2 is a volume of said combusted fuel charge subsequent to said constant volume heat addition;
wherein V3 is a volume of said combusted fuel charge when stored within said storage tank and supplied to said load; and
wherein V4 is a volume of said combusted fuel charge subsequent to work done at said load.

11. The process as claimed in claim 8, wherein:
T0<T1<T2;
T2>T3;
T4<T3; and
T0<T4;
wherein T0 is a temperature of said atmospheric air;
wherein T1 is a temperature of said atmospheric air subsequent to said compression;
wherein T2 is a temperature of said combusted fuel charge subsequent to said constant volume heat addition;
wherein T3 is a temperature of said combusted fuel charge when stored within said storage tank and supplied to said load; and
wherein T4 is a temperature of said combusted fuel charge subsequent to work done at said load.

12. The process as claimed in claim 8, wherein the step of supplying said combusted fuel charge to said storage tank includes:
initially supplying said combusted fuel charge to said storage tank under the effect of a pressure difference between said combustion chamber and said storage tank until the pressure between said combustion chamber and said storage tank equalizes; and
equalizing subsequent pressure, pushing the remaining combusted fuel charge out of said combustion chamber and into said storage tank via a piston disposed within said combustion chamber, wherein said piston is acted upon by force supplied by compressed air supplied to said combustion chamber from an opposite operative end of said combustion chamber.
